(19) United States
(12) Patent Application Publication
(10) Pub. No.: US 2026/0019510 A1
(43) Pub. Date: Jan. 15, 2026

(54) SCANNER OUTPUTTING TARGET OBJECT BASED ON SCAN DATA PROCESSED BY TRAINED MACHINE LEARNING MODEL

(71) Applicant: BROTHER KOGYO KABUSHIKI KAISHA, Nagoya (JP)

(72) Inventor: Yukiyoshi HANAYAMA, Inazawa (JP)

(21) Appl. No.: 19/256,331

(22) Filed: Jul. 1, 2025

(30) Foreign Application Priority Data
Jul. 9, 2024 (JP) 2024-110277

(51) Int. Cl. H04N 1/00; H04N 1/409

(52) U.S. Cl. CPC H04N 1/00244; H04N 1/00413; H04N 1/0044; H04N 1/409; H04N 2201/0094

(57) ABSTRACT

A controller of a scanner performs a first scan process in a case where a first scan instruction is received. The first scan process includes scanning a document using a scanning engine to generate first scan data representing a first document image. The controller sends the first scan data to a server through the communication interface. The controller performs a first outputting process in a case where first processed scan data is received from the server. The first processed scan data is generated by a trained machine learning model by processing on one or more target sub-images in accordance with an image type. Each target sub-images is included in a corresponding region in the first document image. The first outputting process includes outputting a first target object. The first target object is the first processed scan data or an object based on the first processed scan data.

### REFERENCE TO RELATED APPLICATIONS

This application claims priority from Japanese Patent Application No. 2024-110277 filed on Jul. 9, 2024. The entire content of the priority application is incorporated herein by reference.

### BACKGROUND ART

A known scanner outputs image data for a scanned image in accordance with scan settings suited to the type of image in the document. For example, a scanner is configured to accept operations from a user to select an image type and to adjust a correction amount for show-through based on the selected image type.

### SUMMARY

However, since the known technology requires the user to select the image type, the selection result depends on the user's perception, and users do not always select an appropriate image type. Another technology has the scanner automatically select the image type. However, in a case where the document image contains a mixture of text and photos, suitable output results are not always produced when the image type is selected automatically.

In view of the foregoing, it is an object of the present disclosure to provide a scanner that can output results of scanning suitable for the type of a document.

In order to attain the above and other objects, the present disclosure provides a scanner. The scanner includes a scanning engine, a user interface, a communication interface, and a controller including one or more processors. The controller being configured to perform: a first scan process in a case where a first scan instruction is received through the user interface, the first scan process including: scanning a document using the scanning engine to generate first scan data representing a first document image; a first sending process in a case where the first scan process is completed, the first sending process including: sending the first scan data to a server through the communication interface; and a first outputting process in a case where first processed scan data is received from the server through the communication interface subsequently to the first sending process, the first processed scan data being generated by a trained machine learning model performing a model-side process on the first scan data received by the server, the model-side process including: processing on one or more target sub-images of one or more sub-images in accordance with an image type of each of the one or more target sub-images, each of the one or more sub-images being included in a corresponding one of one or more regions in the first document image, the first outputting process including: outputting a first target object, the first target object being the first processed scan data or an object based on the first processed scan data.

According to the above structure, using the trained machine learning model to generate the processed scan data can increase the likelihood that the scanner will output the first target object based on the first processed scan data having undergone suitable image processing, even when the user does not select the image type.

### BRIEF DESCRIPTION OF DRAWINGS

FIG. 1 is an illustration of an overall structure of a multifunction peripheral.

FIG. 2 is a sequence diagram illustrating an example of a copy procedure.

FIGS. 3A through 3C are illustrations showing operation procedures to execute a copy.

FIG. 4 is an illustration of an example of a document image.

FIG. 5 is a sequence diagram illustrating an example of an AI automatic procedure.

FIG. 6 is an illustration of examples of separated regions of scan data specified by a trained model.

FIG. 7 is an illustration of an example of a preview screen.

### DESCRIPTION

Below, an embodiment of a scanner according to the present disclosure will be described while referring to the accompanying drawings. In this specification, the scanner of the present disclosure is applied to a multifunction peripheral (hereinafter “MFP”) having various functions, including an image-reading function and a communication function.

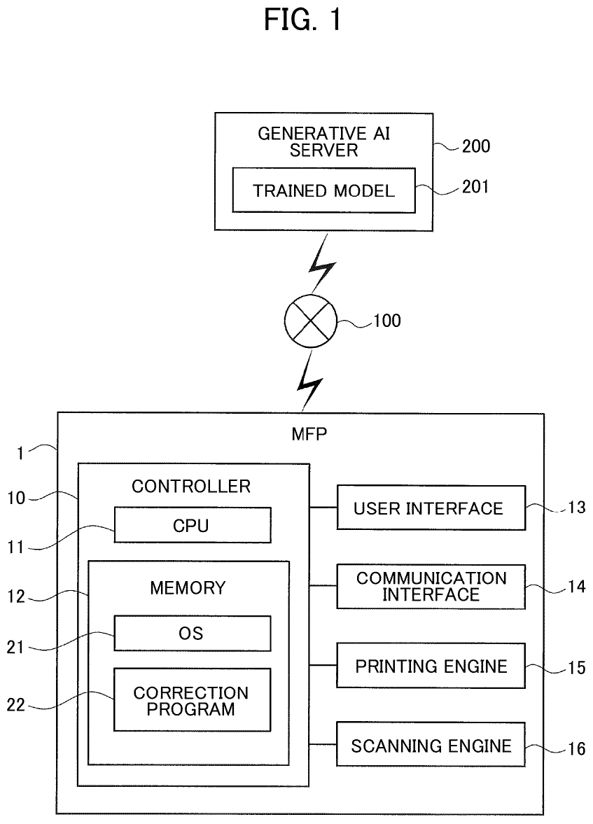

FIG. 1 shows an example of an MFP 1 according to the present embodiment. The MFP 1 includes a controller 10. The controller 10 includes a CPU 11 and a memory 12. The MFP 1 includes a user interface 13, a communication interface 14, a printing engine 15, and a scanning engine 16, all of which are electrically connected to the controller 10. Note that the controller 10 in FIG. 1 is a general concept that covers all hardware and software used for controlling the MFP 1 and is not limited to representing a single piece of hardware actually present in the MFP 1. The MFP 1 is an example of a scanner.

The CPU 11 of the MFP 1 executes various processes according to programs read from the memory 12 or based on user operations. The memory 12 of the MFP 1 stores various programs and data, including an operating system (hereinafter “OS”) 21 and an image correction program 22. The memory 12 is used as a work area when executing various processes. A buffer included in the CPU 11 is an example of the memory 12. The programs and data will be described later in greater detail.

Examples of the memory 12 may include ROM, RAM, or a hard disk drive built into the MFP 1, or may be a storage medium that is readable and writable by the CPU 11. A USB memory connected to the MFP 1, an external memory such as a hard disk drive, and a memory or hard disk drive included in a device connected to the MFP 1 via the communication interface 14 are all examples of memory.

A computer-readable storage medium is a non-transitory medium. Non-transitory media include CD-ROM and DVD-ROM. A non-transitory medium is also a tangible medium. On the other hand, electric signals that convey programs downloaded from a device on the Internet such as a server are a computer-readable signal medium, which is one type of computer-readable medium but is not a non-transitory computer-readable storage medium.

The user interface 13 includes hardware that displays screens for reporting information to the user, and hardware that receives user operations. The user interface 13 may include a touchscreen having a function for displaying screens and a function for receiving operations, or may include a combination of a display and hardware buttons.

The communication interface 14 includes hardware for communicating with external devices. The communication interface 14 includes functions supporting such communication standards as Wi-Fi (U.S. trademark of Wi-Fi Alliance CORPORATION), Ethernet, and Universal Serial Bus (USB). The MFP 1 may also include a plurality of communication interfaces 14 supporting a plurality of communication standards.

The printing engine 15 includes configurations for printing images on print media such as print sheets. The method of image formation used by the printing engine 15 may be the electrophotographic method or the inkjet method, for example. In this embodiment, the printing engine 15 can perform both color printing using colorants of multiple colors, and single-color printing using a single colorant.

The scanning engine 16 includes a configuration for scanning a document placed on a flatbed or a document set in a document feeder and conveyed to a reading position, and for generating scan data as the scanning results. In the present embodiment, the MFP 1 includes the scanning engine 16 that can perform color scanning in which the document is read as a color image, and monochrome scanning in which the document is read as a monochrome image.

As shown in FIG. 1, the MFP 1 can connect to an internet 100 via the communication interface 14 and can access a generative AI server 200, for example. The generative AI server 200 includes a trained model 201. The trained model 201 is a trained machine learning model which has been pre-trained using various types of data to output response data based on the input data. The trained model 201 may be a server made available on the internet 100 by an AI company. One example of an AI company is OpenAI. The generative AI server 200 is an example of the server using the trained machine learning model.

The trained model 201 has been trained so that when image data is inputted in the trained model 201, the trained model 201 can divide (or segment) the entire image represented by that image data into a plurality of regions and can recognize the type of image contained in each region. For example, the types of images include a text type and a non-text type. In such a case, the trained model 201 can divide the entire image into the plurality of regions and recognize, from among the plurality of regions, one or more regions of the text type and one or more regions of the non-text type as distinct.

For convenience, the following terms and notation will be employed in this specification. The act of dividing an image into a plurality of regions and recognizing the type of image in each region will be referred to simply as “region separation,” “separating image data,” “separating,” or “segmentation.” The term “image type” refers to the type of image. Images of certain types will be described using the format “image type + ‘image’”. For example, an image whose type is text will simply be called a “text image.” The notation “image type + ‘region’” will signify a region having an image of that type. The notation “image type+‘image’” may also be used to indicate a region having an image of that type.

In addition to text, the trained model 201 may be capable of recognizing photographs, receipts, diagrams, tables, and illustrations, as image types. For example, the generative AI server 200 may store information specifying a plurality of predetermined types as image types for the trained model 201. The generative AI server 200 may store no information specifying an image type and the trained model 201 may be able to recognize types of images without using such information specifying an image type. The trained model 201 may store therein the information specifying image types for use to recognize types of images. Or, the trained model 201 may refer to a system combination of a machine learning model and reference data including the information specifying image types.

The trained model 201 has been trained to be able to process separated image data in such a manner that for each region, an image process suitable for the type of image in the each region is performed on the image in the each region. The separated image data may include information indicating image types of the regions and positional attributes of the regions. For example, the trained model 201 can apply an edge enhancement process, which is an image process suitable for text images, to text regions. The trained model 201 can also apply an error diffusion process, which is an image process suitable for photographic images, to photo regions.

Trained models on servers prepared by AI companies are trained using big data, for example. Therefore, such trained models can be expected to be capable of analyzing image data, separating the image data into regions of different image types, and performing the image process suitable for each separated region.

The trained model 201 may also be trained to perform smoothing processes used to smooth the boundary of each region when applying different image processes to regions according to their image type. Further, when performing image processes suited to each type of image as well as a smoothing process, the generative AI server 200 may be trained to be able to perform these processes without reducing the number of pixels.

The generative AI server 200 may include an application programming interface (API) for instructing the trained model 201 to separate image data. The generative AI server 200 may further include an API for instructing the trained model 201 to output processed image data that is image data after image processes have been applied to separated regions. The API may be a part of an operating system of the generative AI server 200. For example, the MFP 1 may be capable of instructing the trained model 201 to output processed image data by using the API in the generative AI server 200 for instructing the trained model 201 to output the processed image data.

Alternatively, the generative AI server 200 may accept instructions in the form of a prompt, i.e., in the form of a character string. For example, the MFP 1 may be capable of instructing the trained model 201 to perform region separation and processing image data by inputting the image data into the generative AI server 200 together with a prompt instructing the generative AI server 200 to separate the image data into regions and to perform an image process suitable for an image in each region.

A procedure to scan an image performed by the MFP 1 will be described next. In the following description, actions such as “determine,” “extract,” “select,” “calculate,” “set,” “identify,” “acquire,” “obtain,” “receive,” “control,” “set,” represent processes performed by the CPU 11. Processes performed by the CPU 11 include processes that control hardware using APIs included in an operating system (OS). In the description, an operation of each program is described without referring to the OS. For example, expressions, such as “program B controls hardware C” may indicate “program B controls hardware C by using an API included in the OS”. Further, processes performed by the CPU 11 according to instructions described in a program may be described in abbreviated terms, such as “the CPU 11 executes” or “the program executes”.

In the description, the terms “notice”, “notification”, “report”, “reply”, “response”, and “answer” are used not only to refer to communication directed to a person, but also refer to communication between devices or information transmission or reception between devices. Note that the term “acquire” in this specification is used as a concept that does not necessarily require a request. In other words, a process by which the CPU 11 receives data without requesting that data is included in the concept of “the CPU 11 acquires data.” The term “data” described herein is expressed as bit strings that can be read by a computer. Data of different formats are treated as the same data when the content of the data is essentially the same. The same holds true for “information” in this specification. An “instruction,” and a “request,” is processed by outputting information indicating the “instruction,” and the “request.” The terms “instruction” and “request” may also be used to describe information indicating an “instruction,” and a “request.”

Further, a process performed by the CPU 11 to determine whether information A indicates circumstance B may be described conceptually as “determining whether circumstance B based on information A.” A process in which the CPU 11 determines whether information A indicates circumstance B or circumstance C may be described conceptually as “determining whether circumstance B or circumstance C based on information A.”

In this specification, a setting item may simply be referred to as a “setting.” Setting values may be referred to simply as “settings.” The term “variable” refers to a container holding a value, which may be referenced or modified during execution of processing. The term “value” or “setting value” refers to specific data assigned to a variable or parameter. The term “parameter” refers to a variable element that receives input or to the value assigned to such an element, depending on the context. A parameter is used as a configurable element that influences processing conditions or behaviors. The term “setting item” refers to a representation, identifier, or name of a variable or parameter.

The process of storing a setting value in memory may be referred to simply as “setting.” An operation for setting a setting value or the act of inputting a setting value may also simply be referred to as “setting.”

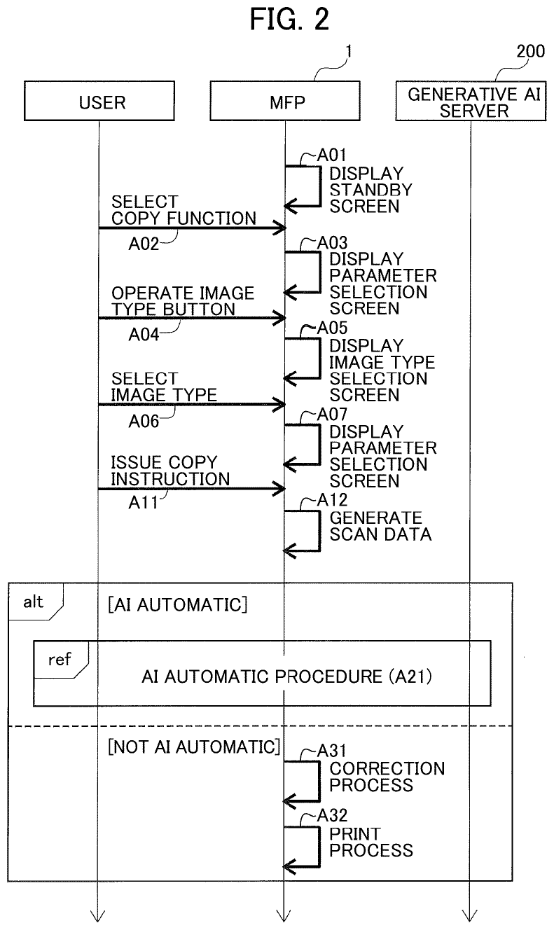

Here, a copy procedure will be described as an example of a scanning-related procedure performed on the MFP 1. The copy procedure is a procedure for executing a print based on scan data generated through a scan. The copy procedure performed on the MFP 1 will be described with reference to the sequence diagram in FIG. 2. It is to be understood that operations, processes, or steps attributed to the MFP 1 is actually executed by the CPU 11.

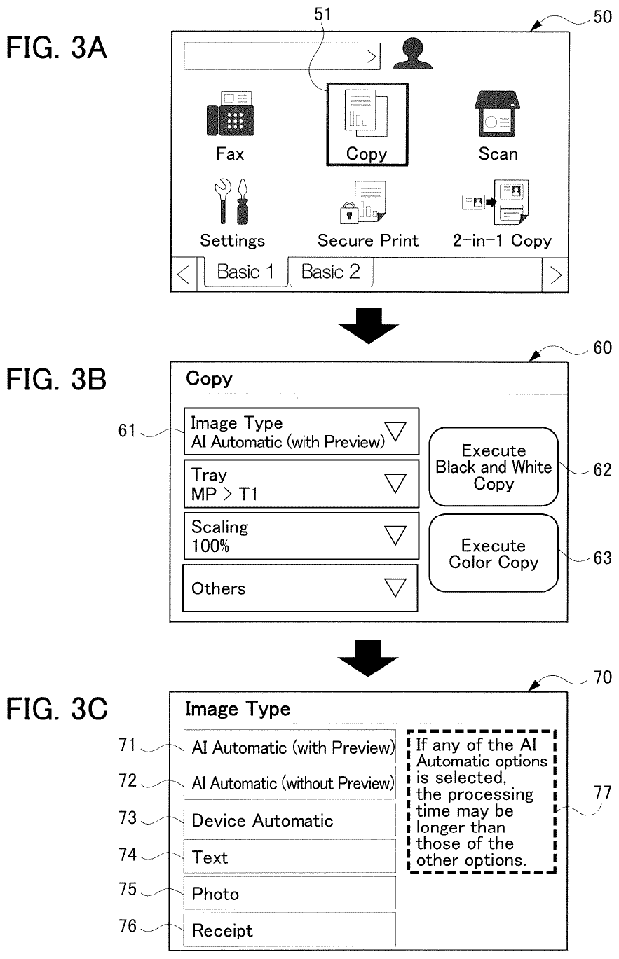

While in a standby state, in A01 the MFP I can display a standby screen on the user interface 13. For example, the MFP 1 displays a standby screen 50 containing a Copy icon 51, as illustrated in FIG. 3A. In addition to the Copy icon 51, the standby screen 50 includes various other icons that each accepts an instruction to perform one of the various functions available on the MFP 1. Through a user operation on a displayed icon, the MFP 1 receives a selection of the function associated with the operated icon. In A02 of this example, the user selects the copy function by operating the Copy icon 51 on the user interface 13.

In this specification, processing targets and content associated with input operations that are represented by images, symbols, or text of a specific size in screens displayed on the user interface 13 will be called “icons” or “buttons” without any distinction. In this specification, “icons” or “buttons” are used as a general concept that is not limited to common icons or buttons but includes operators for accepting input operations such as menu items for accepting selection instructions.

When an operation on the Copy icon 51 is received, in A03 the MFP 1 displays a parameter selection screen 60, such as that shown in FIG. 3B, on the user interface 13 for accepting parameter selections. The parameter selection screen 60 includes an Image Type button 61 for receiving a selection of an image type, a Black and White Copy button 62, and a Color Copy button 63.

In this example, the user performs an operation on the Image Type button 61 in A04. In response to receiving this operation, in A05 the MFP 1 displays an image type selection screen 70, such as that shown in FIG. 3C, on the user interface 13. The image type selection screen 70 includes such options as an AI Automatic (with Preview) button 71, an AI Automatic (without Preview) button 72, a Device Automatic button 73, a Text button 74, a Photo button 75, and a Receipt button 76. As described in detail below, the user can select a processing procedure by operating one of the AI Automatic (with Preview) button 71, AI Automatic (without Preview) button 72, and Device Automatic button 73. Alternatively, in A06 the user can select an image type by operating one of the Text button 74, Photo button 75, and Receipt button 76.

Each of the AI Automatic (with Preview) button 71 and AI Automatic (without Preview) button 72 is an option that accepts an instruction to perform a copy procedure including a procedure using the trained model 201. The procedure using the trained model 201 include a procedure for scanning a document to generate scan data, and a procedure for transmitting generated scan data to the generative AI server 200 including the trained model 201. As described above, the trained model 201 can perform region separation of image data and an image process on an image in each region. The AI Automatic (with Preview) button 71 and AI Automatic (without Preview) button 72 are examples of the first icon.

The AI Automatic (with Preview) button 71 is an option to perform a procedure that includes a preview procedure for previewing separation results following the separation procedure by the trained model 201 but prior to any correction procedures. The AI Automatic (without Preview) button 72 is an option for performing a procedure that does not include the preview procedure. The AI Automatic (with Preview) button 71 is an example of an icon for a process including a preview of image and the AI Automatic (without Preview) button 72 is an example of an icon for a process without a preview of image.

Each of the Device Automatic button 73, Text button 74, Photo button 75, and Receipt button 76 is an option that accepts an instruction for performing a copy procedure that does not use the trained model 201. When the user has selected one of the Device Automatic button 73, Text button 74, Photo button 75, and Receipt button 76, the MFP 1 scans the document to generate scan data but does not transmit the generated scan data to the generative AI server 200. The Device Automatic button 73, Text button 74, Photo button 75, and Receipt button 76 are examples of the second icon.

The Device Automatic button 73 is an option to perform an automatic determination procedure in which the MFP 1 analyzes the generated scan data and determines the type of image represented by the scan data. Displaying the Device Automatic button 73 enables the user to select an automatic determination in which the MFP 1 determines the image type, thereby reducing the user's burden for considering the type of image.

Each of the Text button 74, Photo button 75, and Receipt button 76, on the other hand, is an option for accepting a user specification of an image type prior to generating scan data. For example, when an operation on the Text button 74 has been received, the MFP 1 determines that the image type is text without analyzing the scan data. When the user is aware of the type of image contained in the document, selecting one of the Text button 74, Photo button 75, and Receipt button 76 eliminates processing performed by the MFP 1 and the trained model 201 and can reduce the time for the MFP 1 to output copy results. Image types that can be specified are not limited to the three types of text, photos, and receipts, but may be the two types of text and non-text, or four or more types with the inclusion of other types.

Note that when displaying the image type selection screen 70, the MFP 1 gives priority to the AI Automatic (with Preview) button 71 and AI Automatic (without Preview) button 72 over any of the other options, including the Device Automatic button 73, Text button 74, Photo button 75, and Receipt button 76. For example, the MFP 1 may give the AI Automatic (with Preview) button 71 and AI Automatic (without Preview) button 72 priority by displaying these options at positions indicating a higher priority level than those of the other options. In this example, the AI Automatic (with Preview) button 71 and AI Automatic (without Preview) button 72 are positioned above the other options to represent the priority levels. Alternatively, the MFP 1 may display the AI Automatic (with Preview) button 71 and AI Automatic (without Preview) button 72 at a larger size or in a more conspicuous color than the other options or may accentuate the priority options with borders, or a flashing display. In this way, the user is more likely to select the AI Automatic (with Preview) button 71 and AI Automatic (without Preview) button 72, which are procedures that use the trained model 201 and are more likely to produce copy results of a higher quality.

As shown in FIG. 3C, the MFP 1 also gives priority to the AI Automatic (with Preview) button 71 over the AI Automatic (without Preview) button 72 when displaying the image type selection screen 70. For example, the MFP 1 displays the AI Automatic (with Preview) button 71 larger, more conspicuously, or at a position indicating a higher priority level than that of the AI Automatic (without Preview) button 72 (the AI Automatic (with Preview) button 71 is positioned above the AI Automatic (without Preview) button 72). In other words, the MFP 1 displays the AI Automatic (with Preview) button 71 so that the user is more likely to select the AI Automatic (with Preview) button 71 than the AI Automatic (without Preview) button 72. This is because the separation results of regions produced by the trained model 201 could be different from the user's intention. By obtaining user confirmation through a preview, the MFP 1 can prevent scan data based on separation results not intended by the user from being output.

As shown in FIG. 3B, “AI Automatic (with Preview)” is selected by default in the Image Type button 61 of the parameter selection screen 60 displayed in A03. Thus, when an operation on the Black and White Copy button 62 or Color Copy button 63 is received in the parameter selection screen 60 displayed in A03 without receiving an operation on the Image Type button 61 in A04, the MFP 1 performs the same operations as a case where an operation on the Black and White Copy button 62 or Color Copy button 63 is received in the parameter selection screen 60 displayed in A07 after the AI Automatic (with Preview) button 71 has been selected in the image type selection screen 70 displayed in A05. When “AI Automatic (with Preview)” is set as the default, the user is likely to obtain high-quality copy results simply by operating the Black and White Copy button 62 or the Color Copy button 63.

Since procedures using the trained model 201 take processing time, such procedures are likely to require more processing time overall than procedures not using the trained model 201. Therefore, the MFP 1 displays a message 77 such as that shown in FIG. 3C in association with the AI Automatic (with Preview) button 71 and AI Automatic (without Preview) button 72 indicating that the processing time to complete the procedure may be longer than that of the other options. Displaying information indicating that processing may take a longer time when AI automatic option is selected prior to accepting a selection can be expected to reduce user stress in the event that the processing time of the trained model 201 is lengthy. This message can suggest that the user choose another option when the user wishes to obtain copy results more quickly.

After receiving a user selection in the image type selection screen 70, in A07 the MFP 1 returns the display to the parameter selection screen 60. When the MFP 1 redisplays the parameter selection screen 60 in A07, the Image Type button 61 will include the processing procedure or image type that the user selected in the image type selection screen 70.

In A11 the user sets the document on the flatbed or in the document feeder and issues a copy instruction by operating the Black and White Copy button 62 or the Color Copy button 63 in the parameter selection screen 60.

The instruction issued through the operation on the Black and White Copy button 62 or the Color Copy button 63 with the AI Automatic (with Preview) button 71 or AI Automatic (without Preview) button 72 selected is an example of the first instruction to scan. The instruction issued through the operation on the Black and White Copy button 62 or the Color Copy button 63 with the AI Automatic (with Preview) button 71 selected is an example of the first instruction to scan with preview. The instruction issued through the operation on the Black and White Copy button 62 or the Color Copy button 63 with the AI Automatic (without Preview) button 72 selected is an example of the first instruction to scan without preview. The instruction issued through the operation on the Black and White Copy button 62 or the Color Copy button 63 with the Device Automatic button 73, Text button 74, Photo button 75, or Receipt button 76 selected is an example of the second instruction to scan.

The MFP 1 may also display an icon in the standby screen 50 separate from the Copy icon 51 that accepts an instruction to execute an AI automatic copy. This icon is referred to as “AI automatic copy icon.” When the MFP 1 receives an operation on this AI automatic copy icon, the MFP 1 may prompt the user to select whether to include a preview or not, and then may perform the selected procedure. Alternatively, when an operation on the AI automatic copy icon is received, the MFP 1 may perform the same operations as when the AI Automatic with Preview is selected. That is, when an operation on the AI automatic copy icon is received, the MFP 1 may perform operations under the assumption that an instruction for the AI Automatic with Preview is selected. The AI automatic copy icon displayed in the standby screen 50 is an example of the first icon. An instruction issued through the operation on the AI automatic copy icon displayed in the standby screen 50 is an example of the first scan instruction.

In addition to the processing procedure and image type, the MFP 1 may be able to accept instructions for setting various parameters related to scanning or printing. For example, when the MFP 1 receives an operation on a button included in the parameter selection screen 60 for accepting a setting from among various parameters, the MFP 1 displays parameter options on the user interface 13 for the setting item associated with that button. For example, the parameter options are values assignable to the parameter. After the MFP 1 further receives an operation selecting one of the displayed options, the MFP 1 changes the parameter used in scanning or printing for the setting item associated with the operated button to the parameter indicated by the selected option. Default settings for parameters may be stored on the MFP 1 when shipped from the factory or may be values that an administrator or user of the MFP 1 is able to modify after receiving the shipped MFP 1.

Upon receiving an execution instruction in A11, in A12 the MFP 1 drives the scanning engine 16 to read the image of the document and generate scan data. For example, the MFP 1 may perform color reading at a high resolution to generate scan data of color images. The process of A12 is an example of the first scan process and an example of the second scan process. The scan data generated in A12 is an example of the first scan data and an example of the second scan data.

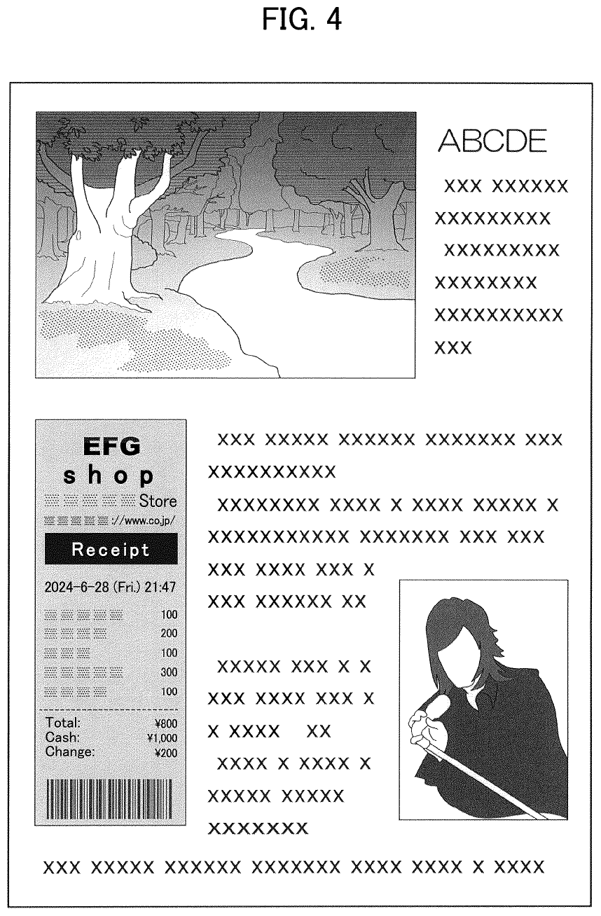

The document is prepared by the user, and a single document image may contain a plurality of types of partial images. For example, the document set in the MFP 1 may include a mixture of text, photos, and receipts, as shown in FIG. 4. Even when scanning a document that contains a plurality of types of partial images, the MFP 1 reads the entire document and generates a single set of scan data representing a single document image containing the plurality of types of partial images.

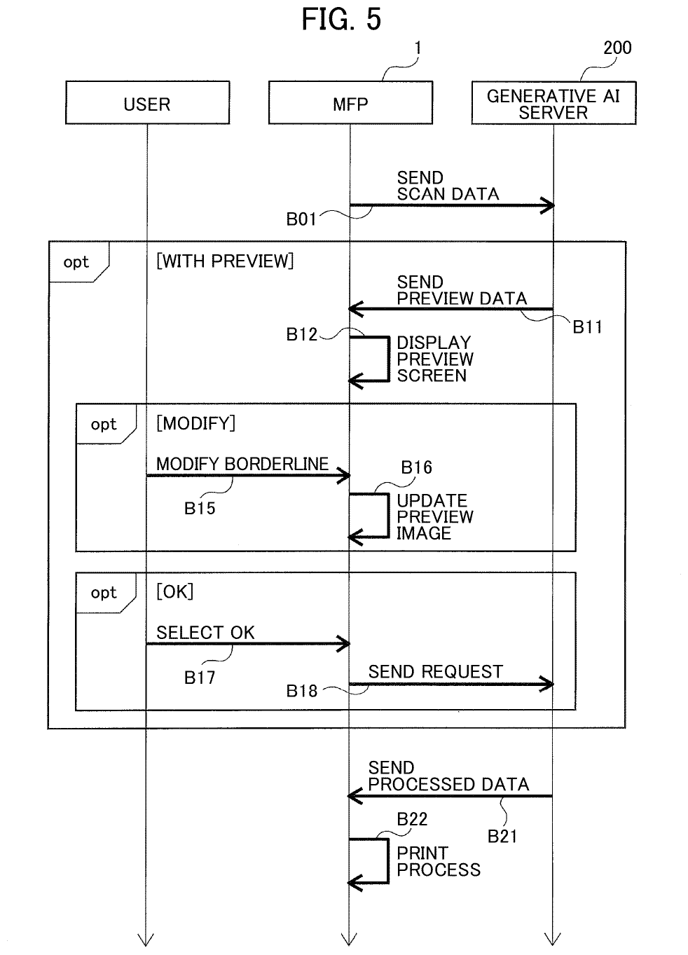

When the execution instruction received in A11 is either “AI Automatic (with Preview)” or “AI Automatic (without Preview)” (alt: AI Automatic), in A21 the MFP 1 executes an AI automatic procedure. The AI automatic procedure will be described next with reference to FIG. 5.

In B01 the MFP 1 transmits the scan data generated in A12 to the generative AI server 200. Here, the MFP 1 issues a request to the generative AI server 200 for preview data when the execution instruction received in A11 is “AI Automatic (with Preview)” and issues an instruction to the generative AI server 200 for processed data when the execution instruction received in A11 is “AI Automatic (without Preview).” The process of B01 is an example of a transmitting process. The following description will first cover the case of “AI Automatic (with Preview).”

When the user selection is “AI Automatic (with Preview)” (opt: With Preview), in B01 the MFP 1 transmits a prescribed instruction specifying “with preview” to the generative AI server 200 with the scan data. The prescribed instruction specifying “with preview” is an instruction requesting that the generative AI server 200 have the trained model 201 separate the image included in the scan data into regions by image type and return preview data showing the separation results. The MFP 1 may also request image data representing an image with a frame enclosing each region separated by image type as the preview data, for example.

Note that the MFP 1 may issue an instruction by sending the scan data to the generative AI server 200 via a dedicated API included in the generative AI server 200 or may issue an instruction through a prompt, for example. The scan data the MFP 1 sends to the generative AI server 200 may be raw data, i.e., unaltered data in the scanning results obtained by the scanning engine 16, or may be processed data that has undergone processing such as a format conversion on the MFP 1.

The generative AI server 200 may also perform various processes on the scan data received from the MFP 1 before inputting the scan data into the trained model 201 to the extent that the data content is not significantly altered. For example, the generative AI server 200 may perform processes known as filtering processes for enhancing features in or removing noise from the scan data. In this specification, inputting scan data sent from the MFP 1 into the trained model 201 after performing various processes falls within the concept of the MFP 1 inputting scan data into the trained model 201.

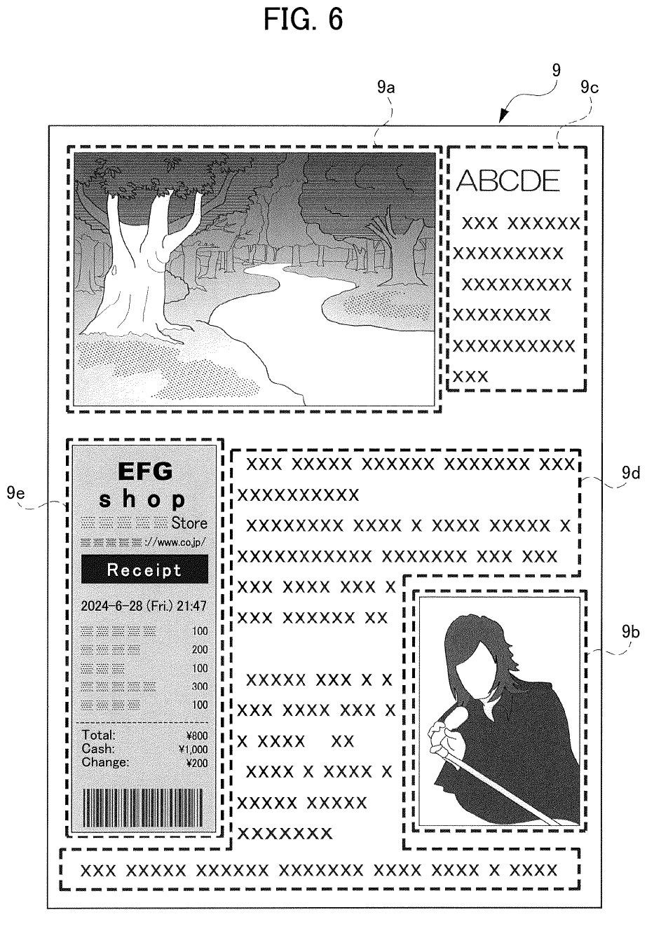

For example, in B01 the MFP 1 transmits the scan data to the generative AI server 200 together with a prompt specifying the instructions, “Separate the entire image of the image data into photo regions, text regions, and receipt regions; enclose the photo regions with blue frames, the text regions with red frames, and the receipt regions with yellow frames; and send separated image data with the color frames superimposed over the original image. The transmitted separated image data will be used in a preview display.” The prompt may further include an instruction indicating that the separated image data is to be generated so that the frames of the regions can be edited or modified through user operation. For example, when the trained model 201 receives scan data generated by reading the document shown in FIG. 4, for example, the trained model 201 generates separated scan data 9 shown in FIG. 6. In this example, the scan data has been separated into photo regions 9a and 9b, text regions 9c and 9d, and a receipt region 9e. Based on the instructions received from the MFP 1, the trained model 201 can generate preview data representing an image having a frame enclosing each separated region and send this preview data to the MFP 1.

After sending, in B01, the scan data with “AI Automatic (with Preview)” selected (opt: With Preview), in B11 the MFP 1 receives the preview data (the separated scan data) from the generative AI server 200. In B12 the MFP 1 displays a preview screen on the user interface 13 based on the preview data received from the generative AI server 200. The preview data is an example of the separated scan data.

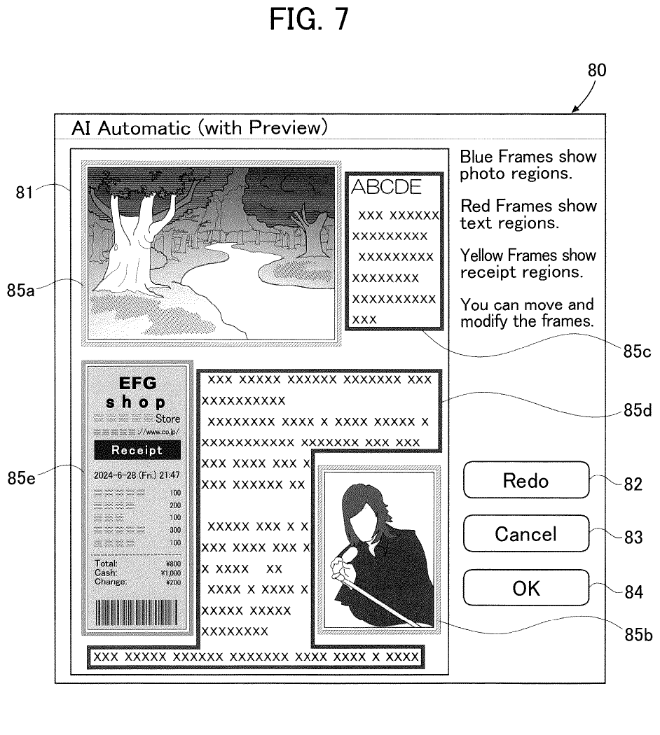

For example, the MFP 1 displays a preview screen 80, as shown in FIG. 7. In this example, the preview screen 80 includes a preview image 81 based on the preview data received from the generative AI server 200, a Redo button 82 that accepts an instruction to repeat the region separation process with the trained model 201, a Cancel button 83 that accepts an instruction to cancel the copy process, and an OK button 84 that accepts an instruction to execute a print. The MFP 1 can then receive a user operation on any of the buttons 82, 83, and 84 in the preview screen 80. The process of B12 is a process that can receive the user operation by displaying the preview screen 80, and an example of the preview process.

The preview image 81 is an image of the scanned document with frames of various colors superposed over a border (borderline or frame) around each region that has been separated by the trained model 201. The preview image 81 shown in FIG. 7 includes photo region frames 85a and 85b, text region frames 85c and 85d, and a receipt region frame 85e. Each of the frames 85a, 85b, 85c, 85d, and 85e is an example of the marker or indicator representing the boundary of the region. The preview image 81 is an example of the image with the marker or indicator.

By adding the prompt described above when transmitting scan data to the generative AI server 200, the MFP 1 is likely to receive preview data for an image whose regions have been separated by image type and bordered by frames having different colors according to the type of image. However, the MFP 1 may reissue the instruction in B01 when determining that the data received from the generative AI server 200 in B11 is not suitable preview data or when a predetermined time has elapsed without having received any preview data.

When checking the preview screen 80, the user can adjust the positions and shapes of the frames and can operate one of the Redo button 82, Cancel button 83, and OK button 84. Note that the frames are displayed as separate objects from the image and are able to receive user operations.

When the MFP 1 receives an operation to alter a frame, i.e., an operation to modify the borderlines of a region (opt: modify, B15), in B16 the MFP 1 changes the frame based on the user operation and redisplays the preview screen 80 with the updated preview image 81. When the MFP 1 receives an operation selecting one of the displayed frames, for example, the MFP 1 may be able to accept operations to adjust that frame. The MFP 1 can continue to accept user operations through the updated preview screen 80.

When the MFP 1 receives an operation on the OK button 84 (opt: OK, B17), in B18 the MFP 1 sends a request to the generative AI server 200 to transmit processed data that has undergone a suitable image process on an image of each region. For example, in B18 the MFP 1 transmits a prompt to the generative AI server 200 with the instructions, “Perform optimal image processing on an image in each of the separated regions and transmit image data combining all processed regions. The boundaries of the regions should be joined together seamlessly. Processes should also be performed so as not to degrade image quality.” The prompt may include an instruction “The boundary of each region should be smoothed.” The operation on the OK button 84 is an example of a selection operation of outputting the scan data. The process of B18 is an example of the process after transmitting process.

When a borderline has been modified through an operation in B15, in B18 the MFP 1 sends a transmission request to the generative AI server 200 together with information indicating the position of the modified frame or the preview image 81 included in the updated preview screen 80 and instructs the generative AI server 200 to perform processing based on the modified region.

In B21 the MFP 1 receives processed data from the generative AI server 200 produced through image processing by the trained model 201 based on the request in B18. In B22 the MFP 1 executes a print based on this processed data. The processed data received in B21 is an example of the first processed scan data. The process of B22 is an example of the first outputting process.

As with the inputted data, the generative AI server 200 may perform various processes on data outputted from the trained model 201 before transmitting the data to the MFP 1 to the extent that the content of the data is not significantly altered. In this specification, the MFP 1 receiving data that has undergone various processes after being outputted from the trained model 201 falls within the concept of the MFP 1 receiving data outputted from the trained model.

When the processed data transmitted from the generative AI server 200 is produced by having the trained model 201 separate the entire image of the scan data into regions by type of image based on the instructions from the MFP 1 and apply an image process on an image in each separated region suitable for the type of image in that region, then the MFP 1 is likely to obtain copy results appropriate for the document's images. The image process suitable for the type of image is, for example, strong denoising and edge enhancement when the image type is text; mild denoising and smoothing when the image type is a photo; and strong denoising, edge enhancement, and density adjustments when the image type is a receipt.

The process performed in response to an instruction to join boundaries seamlessly may include a process that reduces sudden changes in intensity values between opposite sides of the border, such as a smoothing process or other process that does not remove background color or noise in its entirety. When the trained model 201 has been trained to perform a smoothing process, then the generative AI server 200 can likely return processed data that has undergone the smoothing process in accordance with the instructions received in B18. Having the trained model 201 smooth the boundary of each separated region can prevent the appearance of noticeable boundaries between regions produced from the image processes.

The process performed in response to an instruction not to degrade image quality is a process that does not reduce the number of pixels and that maintains the tonal gradation or tonality of the overall image. For example, an image process that decreases the number of pixels may causes the copy results to exhibit a grainy appearance. By issuing instructions in B18, the MFP 1 is likely to obtain high-quality copy results since the generative AI server 200 is likely to send processed data that has undergone the smoothing process without degrading image quality. The prompt sent in B18 may include an instruction that the number of pixels is maintained when processing scan data.

When “AI Automatic (with Preview)” is selected, the MFP 1 displays the preview screen 80 that contains the preview image 81 and can receive a user operation on the OK button 84. That is, since the MFP 1 displays the results of region separation performed by the generative AI server 200 and obtains user confirmation, the MFP 1 can prevent copy results based on separation results not conforming with the user's intention from being output.

The MFP 1 can also accept instructions in the preview screen 80 to adjust frames (borderlines) showing the separation results by the trained model 201 and can display an updated preview image 81 when a frame is adjusted. When the MFP 1 subsequently receives an operation on the OK button 84 in the updated preview screen 80, the MFP 1 transmits information on the updated preview image 81 to the generative AI server 200 and instructs the generative AI server 200 to perform image processing based on the borders of regions corresponding to the updated frame. Accordingly, the MFP 1 can output copy results based on separation results that conform to the user's intention.

When the MFP 1 receives an operation on the Redo button 82 in the preview screen 80, the MFP 1 returns to B01, resends scan data to the generative AI server 200, and receives new preview data. Processing results by the trained model 201 may be different even when the MFP 1 transmits the same scan data and the same prompt.

When the MFP 1 receives an operation on the Cancel button 83 in the preview screen 80, the MFP 1 cancels the copy-related process and returns the display to the standby screen 50.

When “AI Automatic (without Preview)” is selected instead of “AI Automatic (with Preview),” on the other hand, in B01 the MFP 1 issues a request to the generative AI server 200 for processed data rather than preview data. The generative AI server 200 generates the processed data by having the trained model 201 separate the entire image of the scan data into regions of each image type and performing an image process suitable for each separated region on the image in that separated region.

For example, in B01 the MFP 1 sends scan data to the generative AI server 200 together with a prompt specifying the instructions, “Separate the entire image of the image data into photo regions, text regions, and receipt regions; perform optimal image processing on an image in each region; and transmit image data combining all processed regions. The boundaries of the regions should be joined together seamlessly. Processing should also be performed so as not to degrade image quality.” The prompt sent in B01 may include an instruction that the number of pixels is maintained when processing scan data.

When the MFP 1 receives process data from the generative AI server 200 in B21 in response to the instructions sent in B01 or the instructions sent in B01 and B18, in B22 the MFP 1 executes a print based on the processed data. Having sent the prompt described above, the MFP 1 is likely to receive processed data from the generative AI server 200 that has undergone a suitable image process on an image in each region. The process of B22 is an example of the first outputting process.

Returning to the description in FIG. 2, when the execution instruction inputted in A11 is neither “AI Automatic (with Preview)” nor “AI Automatic (without Preview)” (alt: not AI Automatic), the MFP 1 does not perform a process using the generative AI server 200. In this case, in A31 the MFP 1 corrects the scan data generated in A12 based on the user's instructions according to the image correction program 22. In A32 the MFP 1 then executes a print based on the corrected scan data. The process of A31 is an example of the correction process. The data that has undergone the correction process is an example of the second processed scan data. The process of A32 is an example of the second outputting process.

For example, when the MFP I receives an operation on the Text button 74 or the Receipt button 76 in the image type selection screen 70 shown in FIG. 3C and subsequently receives an execution instruction in A11, in A31 the MFP 1 subjects the entire image represented by the scan data to an image process, as a correction process, for text or receipts. For example, the MFP 1 performs strong denoising and edge enhancement processes. When the entire image of the document is a text image, this processing will likely produce suitable copy results. However, when the document contains a mixture of various images, as in the example of FIG. 4, fine wrinkles in human skin or intricate shadows in the background scenery may be oddly accentuated in copy results.

As another example, when the MFP 1 receives an operation on the Photo button 75 in the image type selection screen 70 shown in FIG. 3C and subsequently receives an execution instruction in A11, in A31 the MFP 1 subjects the entire image represented by the scan data to image processing for photos. For example, the MFP 1 may perform mild denoising and smoothing. When the entire image on the original includes only of photos, this processing is likely to produce suitable copy results. However, when the original contains a mixture of various images, as in the example of FIG. 4, small numbers on a receipt may appear blurred in the copy.

Further, when the MFP 1 receives an operation on the Device Automatic button 73 in the image type selection screen 70 shown in FIG. 3C and subsequently receives an execution instruction in A11, in A31 the MFP 1 analyzes the scan data, determines whether the overall image is of the type text, photos, or receipts, and performs image processing for the determined type. When the original contains a mixture of various images, as in the example of FIG. 4, the corrections performed may be inappropriate, as described above, no matter what type has been determined.

Thus, when the entire image of a document has a single image type and the user is familiar with the type of image on the document, the user may select one of the Device Automatic button 73, Text button 74, Photo button 75, and Receipt button 76 to perform processing that avoids the lengthy processing time of the trained model 201. As a result, the processing time to produce output is shorter than that of an AI automatic procedure, and the user is likely to obtain the copy output more quickly.

In contrast, when the MFP 1 receives an operation on the AI Automatic (with Preview) button 71 or the AI Automatic (without Preview) button 72, suitable corrections are likely to be conducted in each region of the image since the trained model 201 is used to separate regions by type and printing is performed based on processed data produced by subjecting each region to an image process suited to the image type in that region. When using the trained model 201, it is likely that a suitable image process will be performed in each region of the image and the data outputted can be expected to be of high quality. Further, the generative AI server 200 can performs processing automatically without user-specified information on a type of image. Hence, even users unfamiliar with the image types are likely to obtain suitable copy output.

In addition to AI automatic procedures using the trained model 201, the MFP 1 allows the user to specify the image type for the overall image. Accordingly, the user can select a scanning procedure based on the type of document and the user's knowledge.

The MFP 1 can receive operations on icons other than the Copy icon 51 in the standby screen 50 shown in FIG. 3A. For example, when the MFP 1 receives a scanning instruction through an operation on the Scan icon, the MFP 1 can also use the trained model 201 of the generative AI server 200.

When receiving an operation on the Scan icon, the MFP I can further accept the designation of a save location as the output destination for the scan data, and the designation of a file format for the data being saved. The save location may be in the memory 12 of the MFP 1, in a USB memory mounted in the MFP 1, or on an external device or in external storage with which the MFP 1 can communicate.

In response to a scanning instruction, the MFP 1 may scan the document to generate scan data and transmit the scan data to the generative AI server 200. The MFP 1 may also instruct the generative AI server 200 to separate the entire image of the scan data into regions according to image type and to perform an image process on an image in each separated region according to the image type in that region. The MFP 1 may also instruct the generative AI server 200 to output the processed data in the designated file format. Once processed data converted to the designated file format has been received from the generative AI server 200, the MFP 1 can output this processed data to be saved in the designated save location. Saving the processed data in the designated file format upon reception enables the user to readily use the saved data.

As described above, the MFP 1 in the present embodiment transmits scan data generated by scanning a document to the generative AI server 200 using the trained model 201. The trained model 201 has been trained to perform both region separation by image type based on inputted scan data, and suitable image processing for each image type in the separated regions. In a case where processed data is received from the generative AI server 200 after sending the scan data, the MFP 1 performs output using that processed data. The processed data is likely to be data produced by having the trained model 201 separate the image represented by the scan data into regions of different image types and perform a suitable image process on an image in each region according to image type in that region. This increases the likelihood that the MFP 1 will output an image having undergone suitable image processing, even when the user does not select the image type.

While the invention has been described in conjunction with various example structures outlined above and illustrated in the figures, various alternatives, modifications, variations, improvements, and substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and or substantial equivalents. Some specific examples of potential alternatives, modifications, or variations in the described invention are described below: For example, the scanner is not limited to the MFP 1 but may be a copier, a fax machine, or any other device having an image reading function and a communication function.

The display formats are also not limited to the examples in the drawings. For example, the number, types, and shapes of icons displayed in the standby screen 50 are not limited to the examples in the drawings. Similarly, the types and shapes of buttons displayed in the parameter selection screen 60 and image type selection screen 70 are not limited to the examples in the drawings.

In the above embodiment, the MFP 1 can accept a selection in the image type selection screen 70 (see FIG. 3C) for one of “AI Automatic (with Preview)” and “AI Automatic (without Preview),” but the MFP 1 may be configured to accept one of these two options. That is, the MFP 1 may be configured to display, as an option using the trained model 201, either one of “AI Automatic (with Preview)” and “AI Automatic (without Preview),” in addition to other options without using the trained model 201, such as f the buttons 73-76. While the MFP 1 in the above embodiment accepts operations in the preview screen 80 (see FIG. 7) to adjust the frames, the MFP 1 may not accept such modification operations. In this case, for example, when the user does not consider the separated regions appropriate, the user may simply operate the Redo button 82 to have the trained model 201 repeat the process of separating regions.

While the above embodiment describes procedures in which the trained model 201 is not given specific instructions on the types of images to be identified when separating regions and the image process to be performed for each image type, the MFP 1 may indicate specific image types and image processes when instructing the trained model 201 to perform image processing. For example, the MFP 1 may instruct the trained model 201 to “sort image regions by photos, text, and receipts.” As another example, the MFP 1 may instruct the trained model 201 to “perform error diffusion on photo regions.” However, the trained model 201 can use image types and image processes not possessed by the MFP 1 when no image types or processes are specified.

While the MFP 1 in the above embodiment has the trained model 201 separate an image into regions and perform an image process on an image in each region when receiving a selection for an AI automatic procedure, the user may select a procedure to be performed by the trained model 201 in which the trained model 201 only separates the image into regions or only performs an image process on an image in each region.

The above embodiment describes a procedure in which the MFP 1 generates scan data using the scanning engine 16 in the MFP 1 itself and transmits the scan data to the generative AI server 200 via the communication interface 14 in the MFP 1. However, the generation of scan data and the transmission of scan data may be performed by separate devices. For example, scan data generated by a scanner may be received by a terminal device separate from the scanner. In this case, the terminal device sends the received scan data to the generative AI server 200 via a communication interface in the terminal device.

The generative AI server 200 is not limited to being a server that possesses the trained model 201 but may be capable of accessing the trained model 201 on another server. In such a case, the generative AI server 200 transfers the scan data received from the MFP 1 to the other server possessing the trained model 201 and sends response data to the MFP 1 based on the response received from this trained model 201. The generative AI server 200 is not limited to a server prepared by an AI company such as Open AI but may be a dedicated server prepared by the manufacturer of the MFP 1, for example.

The above embodiment describes a configuration using the trained model 201 of the generative AI server 200, but the present disclosure may also be applied to a configuration using a program generated based on programming code by a programmer, instead of the trained model 201.

In any of the flowcharts or sequence diagrams disclosed in the embodiment, the plurality of processes included in any of a plurality of steps may be executed in parallel, or the order in which the processes are performed may be modified in any way that does not produce any inconsistencies in the processes.

The processes in the present disclosure are performed by a single CPU, a plurality of CPUs, hardware such as one or more Application Specific Integrated Circuits (ASICs), or any combination of these components. The discloses processes are achieved through a computer-readable storage medium storing programs used to implement those processes or according to any methods or formats for performing those processes. The term “processor” encompasses both a single processor or a group of multiple processors located either locally or remotely working together or in a distributed fashion to collectively perform the tasks attributed to the “processor” described herein. One or more processors may be referred to as a controller.

Note that the present disclosure includes the phrases such as “at least one of A and B”, “at least one of A, B and C”, as alternative expressions that mean one or more of A and B, one or more of A, B and C, respectively. More specifically, the phrase “at least one of A and B” indicates (A), (B) or (A and B), and the phrase “at least one of A, B and C” indicates (A), (B), (C), (A and B), (A and C), (B and C) or (A, B and C).

What is claimed is:

1. A scanner comprising:
a scanning engine;
a user interface;
a communication interface; and
a controller including one or more processors, the controller being configured to perform:
a first scan process in a case where a first scan instruction is received through the user interface, the first scan process including:
scanning a document using the scanning engine to generate first scan data representing a first document image;
a first sending process in a case where the first scan process is completed, the first sending process including:
sending the first scan data to a server through the communication interface; and
a first outputting process in a case where first processed scan data is received from the server through the communication interface subsequently to the first sending process, the first processed scan data being generated by a trained machine learning model performing a model-side process on the first scan data received by the server, the model-side process including: processing on one or more target sub-images of one or more sub-images in accordance with an image type of each of the one or more target sub-images, each of the one or more sub-images being included in a corresponding one of one or more regions in the first document image, the first outputting process including:
outputting a first target object, the first target object being the first processed scan data or an object based on the first processed scan data.

2. The scanner according to claim 1,
wherein the first sending process further includes:
sending a smoothing instruction in association with the first scan data, the smoothing instruction causing the trained machine learning model to perform the model-side process on the first scan data to generate the first processed scan data in which a boundary of each of the one or more regions is smoothed.

3. The scanner according to claim 1,
wherein the first sending process further includes:
sending a pixel-number instruction to the server in association with the first scan data, the pixel-number instruction causing the trained machine learning model to perform the model-side process on the first scan data to generate the first processed scan data having the number of pixels no less than the number of pixels in the first scan data.

4. The scanner according to claim 1,
wherein the controller is configured to further perform:
a second scan process in a case where a second scan instruction is received through the user interface, the second scan instruction being a scan instruction associated with type information related to an image type of the document, the second scan process including:
scanning the document using the scanning engine to generate second scan data representing a second document image;
a correction process including:
generating second processed scan data based on the second scan data by correcting the second document image in accordance with the image type of the document; and
a second outputting process including:
outputting a second target object, the second target object being the second processed scan data or an object based on the second processed scan data,
wherein the first scan instruction is a scan instruction not associated with the type information,
wherein the first outputting process is performed in a case where the first scan instruction is received through the user interface, the first scan process and the first sending process are completed, and the first processed scan data is received from the server through the communication interface subsequently to the first sending process.

5. The scanner according to claim 4,
wherein in a case where the second scan instruction is received through the user interface and the second scan instruction is associated with the type information indicating a text type as the image type of the document, the second scan data is generated by correcting the second document image in accordance with the text type in the correction process,
wherein in a case where the second scan instruction is received through the user interface and the second scan instruction is associated with the type information indicating a non-text type as the image type of the document, the second scan data is generated by correcting the second document image in accordance with the non-text type in the correction process,
wherein the controller is configured to further perform:
a detection process in a case where the second scan instruction is received through the user interface and the second scan data is associated with the type information indicating execution of automatic detection of the image type of the document, the detection process including:
automatically detecting the image type of the document based on the second scan data,
wherein in a case where the second scan instruction is received through the user interface and the second scan instruction is associated with the type information indicating the execution of the automatic detection, the second scan data is generated by correcting the second document image in accordance with the detected image type of the document in the correction process.

6. The scanner according to claim 4,
wherein the controller is configured to further perform:
a display process including:
displaying, on the user interface, a screen including a first display object and a second display object in such a manner that the first display object is displayed with a higher priority than the second display object, the first display object being related to the first scan instruction, the second display object being related to the second scan instruction,
wherein the controller determines that the first scan instruction is received through the user interface under a condition including a requirement that the controller receives an operation of the first display object without receiving an operation of the second display object.

7. The scanner according to claim 6,
wherein the screen includes notification information indicating a possibility that a duration to complete the first outputting process started under a condition including a requirement that the controller receives the operation of the first display object is longer than a duration to complete the first outputting process started under a condition including a requirement that the controller receives an operation of the second display object.

8. The scanner according to claim 7,
wherein the first scan process and the first sending process are performed in a case where the first scan instruction is received through the user interface and the first scan instruction is associated with a preview instruction,
wherein the controller is configured to further perform:
a preview process in a case where the first scan instruction is received through the user interface, the first scan instruction is associated with the preview instruction, the first scan process and the first sending process are completed, and preview image data is received from the server, the preview process including:
displaying a preview screen on the user interface based on the preview image data, the preview image data being generated based on the first scan data by the trained machine learning model, the preview image data representing a preview image including one or more markers each of which indicates a boundary of a corresponding one of the one or more regions; and
receiving, through the preview screen, a selection input indicating whether to permit the first outputting process; and
a second sending process in a case where the selection input indicates that the first outputting process is permitted, the second sending process including:
sending a request to send the first processed scan data to the server,
wherein the first outputting process is performed in a case where the first processed scan data is received from the server subsequently to the second sending process,
wherein the first scan process and the first sending process are performed in a case where the first scan instruction is received through the user interface and the first scan instruction is not associated with the preview instruction,
wherein the first outputting process is performed in a case where the first scan instruction is received through the user interface, the first scan instruction is not associated with the preview instruction, the first processed scan data is received from the server through the communication interface subsequently to the first sending process, and the preview image data is not received from the server.

9. The scanner according to claim 8,
wherein the first display object includes:
a first icon related to the first scan instruction associated with the preview instruction; and
a second icon related to the first scan instruction not associated with the preview instruction,
wherein the first icon is displayed with a higher priority than the second icon in the screen.

10. The scanner according to claim 8,
wherein the preview process further includes:
receiving a modification input indicating modification of one or more of the one or more markers; and
updating the preview image data to generate updated preview image data based on the modification input in such a manner that the updated preview image data represents an updated preview image including updated one or more markers, the updated one or more markers being the one or more markers reflecting the modification,
wherein in a case where the updated preview image data is generated and the selection input indicates that the first outputting process is permitted, the second sending process further includes:
sending the updated preview image data in association with the request,
wherein the first outputting process is performed in a case where the first processed scan data is received from the server subsequently to the second sending process in which the updated preview image data has been sent in association with the request, the processing in the model-side process is performed based on the updated one or more markers.

11. The scanner according to claim 1,
wherein the controller is configured to further perform:
a preview process in a case where the first scan instruction is received through the user interface, the first scan instruction is associated with a preview instruction, the first scan process and the first sending process are completed, and preview image data is received from the server, the preview process including:
displaying a preview screen on the user interface based on the preview image data, the preview image data being generated based on the first scan data by the trained machine learning model, the preview image data representing a preview image including one or more markers each of which indicates a boundary of a corresponding one of the one or more regions; and
receiving, through the preview screen, a selection input indicating whether to permit the first outputting process; and
a second sending process in a case where the selection input indicates that the first outputting process is permitted, the second sending process including:
sending a request to send the first processed scan data to the server.

12. The scanner according to claim 11,
wherein the preview process further includes:
receiving a modification input indicating modification of one or more of the one or more markers; and
updating the preview image data to generate updated preview image data based on the modification input in such a manner that the updated preview image data represents an updated preview image including updated one or more markers, the updated one or more markers being the one or more markers reflecting the modification,
wherein in a case where the updated preview image data is generated and the selection input indicates that the first outputting process is permitted, the second sending process further includes:
sending the updated preview image data in association with the request,
wherein the first outputting process is performed in a case where the first processed scan data is received from the server subsequently to the second sending process in which the updated preview image data has been sent in association with the request, the processing in the model-side process is performed based on the updated one or more markers.

13. The scanner according to claim 1,
wherein the controller is configured to further perform:
receiving, through the user interface, location information indicating a location;
wherein the outputting including:
storing, as the first target object, the first processed scan data in the location.

14. The scanner according to claim 13,
wherein the controller is configured to further perform:
receiving, through the user interface, format information indicating a specific file format for the first processed scan data,
wherein the first outputting process further includes:
converting the first processed scan data into the specific file format,
wherein in the storing, the first processed scan data converted into the specific file format is stored in the location indicated in the location information.

15. The scanner according to claim 1, further comprising:
a printing engine,
wherein the outputting includes:
printing, as the first target object, an image on a sheet based on the first processed scan data using the printing engine.

16. The scanner according to claim 1,
wherein the controller is configured to further perform:
a display process including:
displaying, on the user interface, a screen including a first display object and a second display object in such a manner that the first display object is displayed with a higher priority than the second display object, the first display object being configured to receive a first usage instruction to use the trained machine learning model, the second display object being configured to receive a second usage instruction not to use the trained machine learning model,
wherein the first scan instruction is receivable through the user interface in a case where the first usage instruction is received, and the first scan instruction is receivable through the user interface in a case where neither the first usage instruction nor the second usage instruction is received.

17. The scanner according to claim 16,
wherein the screen includes notification information indicating a possibility that a duration to complete the first outputting process started under a condition including a requirement that the controller receives an operation of the first display object is longer than a duration to complete the first outputting process started under a condition including a requirement that the controller receives an operation of the second display object.

18. The scanner according to claim 17,
wherein the first scan process and the first sending process are performed in a case where the first scan instruction is received through the user interface and the first scan instruction is associated with a preview instruction,
wherein the controller is configured to further perform:
a preview process in a case where the first scan instruction is received through the user interface, the first scan instruction is associated with the preview instruction, the first scan process and the first sending process are completed, and preview image data is received from the server, the preview process including:
displaying a preview screen on the user interface based on the preview image data, the preview image data being generated based on the first scan data by the trained machine learning model, the preview image data representing a preview image including one or more markers each of which indicates a boundary of a corresponding one of the one or more regions; and
receiving, through the preview screen, a selection input indicating whether to permit the first outputting process; and
a second sending process in a case where the selection input indicates that the first outputting process is permitted, the second sending process including:
sending a request to send the first processed scan data to the server,
wherein the first outputting process is performed in a case where the first processed scan data is received from the server subsequently to the second sending process,
wherein the first scan process and the first sending process are performed in a case where the first scan instruction is received through the user interface and the first scan instruction is not associated with the preview instruction,
wherein the first outputting process is performed in a case where the first scan instruction is received through the user interface, and the first scan instruction is not associated with the preview instruction, the first processed scan data is received from the server through the communication interface subsequently to the first sending process, and the preview image data is not received from the server.

19. The scanner according to claim 18,
wherein the first display object includes:
a first icon configured to receive the first usage instruction associated with the preview instruction; and
a second icon configured to receive the first usage instruction not associated with the preview instruction,
wherein the first icon is displayed with a higher priority than the second icon in the screen.

20. The scanner according to claim 18,
wherein the preview process further includes:
receiving a modification input indicating modification of one or more of the one or more markers; and
updating the preview image data to generate updated preview image data based on the modification input in such a manner that the updated preview image data represents an updated preview image including updated one or more markers, the updated one or more markers being the one or more markers reflecting the modification,
wherein in a case where the updated preview image data is generated and the selection input indicates that the first outputting process is permitted, the second sending process further includes:
sending the updated preview image data in association with the request,
wherein the first outputting process is performed in a case where the first processed scan data is received from the server subsequently to the second sending process in which the updated preview image data has been sent in association with the request, the processing in the model-side process is performed based on the updated one or more markers.
